(19) United States
(12) Patent Application Publication
(10) Pub. No.: US 2022/0340174 A1
(43) Pub. Date: Oct. 27, 2022

(54) UNMANNED DRIVING DEVICE CONTROL

(71) Applicant: Beijing Sankuai Online Technology Co., Ltd., Beijing (CN)

(72) Inventors: Huaxia XIA, Beijing (CN); Xiao LI, Beijing (CN); Yuqin CHEN, Beijing (CN); Dongchun REN, Beijing (CN); Mingyu FAN, Beijing (CN); Bo WANG, Beijing (CN)

(21) Appl. No.: 17/673,801

(22) Filed: Feb. 17, 2022

(30) Foreign Application Priority Data
Apr. 25, 2021 (CN) 202110445217.3

(51) Int. Cl. B60W 60/00; G05D 1/02; G05B 13/02

(52) U.S. Cl. CPC B60W 60/0027; G05D 1/0214; G05D 1/0223; G05B 13/0265; B60W 2556/10; B60W 2554/804; B60W 2554/802; G05D 2201/0212; G05D 1/0221

(57) ABSTRACT

A method and apparatus for controlling an unmanned driving device are provided. An unmanned driving device obtains a travel trajectory of the unmanned driving device as a first trajectory, obtains a travel trajectory of a target object around as a second trajectory, and determines a spatial relation between the unmanned driving device and the target object according to the first trajectory and the second trajectory. Subsequently, the unmanned driving device can code the spatial relation according to a preset coding manner to obtain spatial coding information, where each code in the spatial coding information is configured to represent a spatial relation between the unmanned driving device and the target object at a moment corresponding to the code.

### CROSS REFERENCE TO RELATED APPLICATIONS

This application claims priority to Chinese Patent Application No. 202110445217.3 filed on Apr. 25, 2021, the entire content of which is incorporated herein by reference.

### TECHNICAL FIELD

The present disclosure relates to the field of unmanned driving, and particularly, to methods and apparatuses for controlling an unmanned driving device.

### BACKGROUND

In the field of unmanned driving, an unmanned driving device can determine what kind of interactive behavior it is in during traveling, for example, determine whether it is overtaking or following another vehicle, or determine that there is an oncoming car. After the unmanned driving device determines what kind of interactive behavior it is in, the unmanned driving device can make decisions about next driving.

Currently, the unmanned driving device may identify the interactive behavior of itself through images, point clouds, or the like. However, identifying the interactive behavior requires features of the images, the point clouds, or the like, and some features are redundant, which results in relatively low efficiency when the unmanned driving device identifies the interactive behavior.

Therefore, how to improve the efficiency of identifying the current interactive behavior of the unmanned driving device is a problem to be resolved.

### SUMMARY

A method for controlling an unmanned driving device is provided. In some embodiments, the method includes: obtaining a travel trajectory of an unmanned driving device as a first trajectory, and obtaining a travel trajectory of a target object around the unmanned driving device as a second trajectory; determining a spatial relation between the unmanned driving device and the target object according to the first trajectory and the second trajectory; coding the spatial relation between the unmanned driving device and the target object according to a preset coding manner to obtain spatial coding information, where each code in the spatial coding information is configured to represent a spatial relation between the unmanned driving device and the target object at a moment corresponding to the code; determining an interactive behavior between the unmanned driving device and the target object according to the spatial coding information; and controlling the unmanned driving device according to the interactive behavior.

The present disclosure provides an apparatus for controlling an unmanned driving device, the apparatus including: an obtaining module, configured to obtain a travel trajectory of an unmanned driving device as a first trajectory, and obtain a travel trajectory of a target object around the unmanned driving device as a second trajectory; a relation determining module, configured to determine a spatial relation between the unmanned driving device and the target object according to the first trajectory and the second trajectory; a coding module, configured to code the spatial relation between the unmanned driving device and the target object according to a preset coding manner to obtain spatial coding information, where each code in the spatial coding information is configured to represent a spatial relation between the unmanned driving device and the target object at a moment corresponding to the code; a behavior determining module, configured to determine an interactive behavior between the unmanned driving device and the target object according to the spatial coding information; and a control module, configured to control the unmanned driving device according to the interactive behavior.

In some embodiments, a computer-readable storage medium is provided to store a computer program, the computer program, when executed by a processor, implementing the foregoing method for controlling an unmanned driving device.

In some embodiments, an unmanned driving device is provided, which includes a memory, a processor, and a computer program stored in the memory and executable by the processor, the processor being configured to implement the foregoing method for controlling an unmanned driving device when executing the program.

### BRIEF DESCRIPTION OF DRAWINGS

Accompanying drawings described herein are used for providing further understanding about this specification, and constitute a part of this specification. Exemplary embodiments of this specification and descriptions thereof are used for explaining this specification, and do not constitute an inappropriate limitation on this specification.

FIG. 1 is a schematic flowchart of a method for controlling an unmanned driving device according to the present disclosure;

FIG. 2 is a schematic diagram of a road coordinate system according to the present disclosure;

FIG. 3 is a schematic diagram of spatial coding information according to the present disclosure;

FIG. 4 is a schematic diagram of an apparatus for controlling an unmanned driving device according to the present disclosure; and

FIG. 5 is a schematic diagram of an unmanned driving device corresponding to FIG. 1 according to the present disclosure.

### DETAILED DESCRIPTION

To state the objectives, technical solutions, and advantages in accordance with the present disclosure, example technical solutions in accordance with the present disclosure will be described below with reference to embodiments herein and corresponding accompanying drawings. Apparently, the described embodiments are merely some but not all of the embodiments, and thus are not intended to be limiting. Based on the embodiments herein, all other embodiments obtained by a person of ordinary skill in the art without inventive efforts shall fall within the protection scope of the present disclosure.

The technical solutions provided in some embodiments are described in detail below with reference to the accompanying drawings.

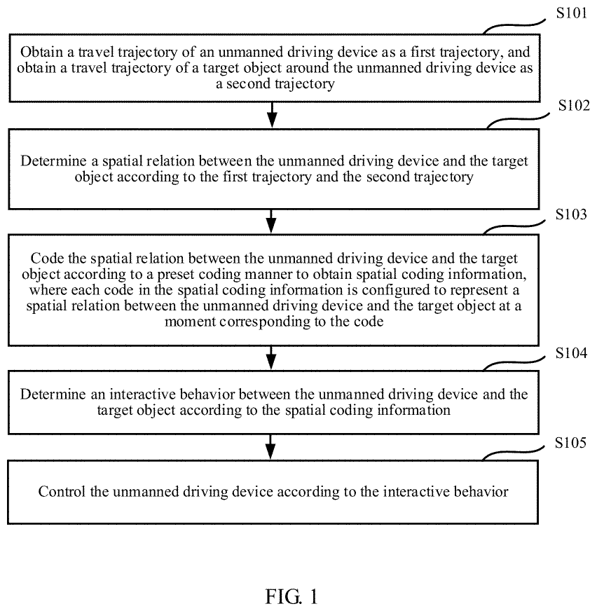

FIG. 1 is a schematic flowchart of a method for controlling an unmanned driving device according to the present disclosure, including steps S101 to S105.

At S101, a travel trajectory of an unmanned driving device is obtained as a first trajectory, and a travel trajectory of a target object around the unmanned driving device is obtained as a second trajectory.

In an embodiment, points of the unmanned driving device in a world coordinate system may be acquired in real time as the first trajectory by using, for example, a Global Positioning System (GPS) system provided in the unmanned driving device, and points of the target object around in the world coordinate system may be acquired in real time as the second trajectory by using a device such as a sensor, an image acquisition apparatus, or a distance detection apparatus provided in the unmanned driving device. The target object around the unmanned driving device can be a target object within a specific distance, for example, 60 m or 90 m, from the unmanned driving device.

At S102, a spatial relation between the unmanned driving device and the target object is determined according to the first trajectory and the second trajectory.

During actual application, the unmanned driving device identifies an interactive behavior that the unmanned driving device is in during traveling, so as to determine a next traveling policy to better control the unmanned driving device to continue driving. Based on the above, the unmanned driving device may obtain the travel trajectory of the unmanned driving device as the first trajectory, and obtain the travel trajectory of the target object around as the second trajectory.

The target object may be an object that can move around, for example, a vehicle, an electric vehicle, or a pedestrian. The unmanned driving device may determine the spatial relation between the unmanned driving device and the target object according to the first trajectory and the second trajectory. The spatial relation between the unmanned driving device and the target object may include a relative position relation, a relative speed relation, or the like. The spatial relation may be a spatial relation between the unmanned driving device and the target object at a plurality of historical moments and a current moment. That is, the first trajectory obtained in the above may include trajectory points of the unmanned driving device at the plurality of historical moments and the current moment, and the second trajectory may include trajectory points of the target object at the plurality of historical moments and the current moment. The unmanned driving device may obtain the first trajectory and the second trajectory that include the current moment and that are in a preset duration, so as to subsequently determine an interactive behavior that the unmanned driving device is currently in.

In the present disclosure, the first trajectory and the second trajectory may be travel trajectories in the world coordinate system. For ease of determining the spatial relation between the unmanned driving device and the target object, the first trajectory and the second trajectory may be transformed into travel trajectories in a road coordinate system. In some embodiments, the unmanned driving device may transform the first trajectory into a travel trajectory in the road coordinate system to obtain the transformed first trajectory, and transform the second trajectory into a travel trajectory in the road coordinate system to obtain the transformed second trajectory, and determine the spatial relation between the unmanned driving device and the target object according to the transformed first trajectory and the transformed second trajectory.

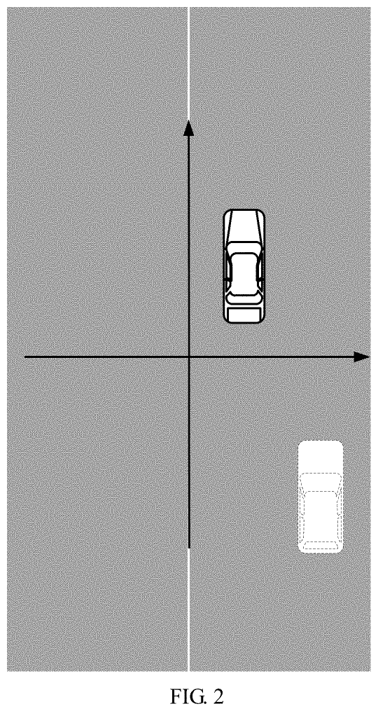

The road coordinate system may be a Frenet coordinate system. The Frenet coordinate system has a strong correlation with the road. By transforming the trajectories into travel trajectories of the vehicle in the Frenet coordinate system, the distance by which the vehicle travels on the road and whether the vehicle is offset on the road can be clearly described as shown in FIG. 2.

FIG. 2 is a schematic diagram of a road coordinate system according to the present disclosure.

From FIG. 2, it can be learned that the vertical axis direction and the horizontal axis direction of the road coordinate system (Frenet coordinate system) are respectively a road travel direction and a transverse direction of the road, that is, a direction perpendicular to the road travel direction. Only a straight road is used as an example in FIG. 2. In practice, the same principle applies to a curved road. The vertical axis direction included in the Frenet coordinate system is a tangent direction of the curved road, and coordinate points of the vehicle in the Frenet coordinate system can indicate a specific distance by which the vehicle travels in a road travel direction and a specific location of the vehicle in a transverse direction of the road.

Transforming the first trajectory and the second trajectory into the travel trajectories in the road coordinate system is to transform the trajectory points of the unmanned driving device and the target object in the world coordinate system into coordinates in the road coordinate system. Regardless of the world coordinate system or the road coordinate system, both the unmanned driving device and the target object may be considered as a point, or the unmanned driving device and the target object may be respectively considered as polygons formed by a plurality of coordinate points.

At a moment, a coordinate point of the unmanned driving device and a coordinate point of the target object in the road coordinate system can clearly indicate a relative position relation between the unmanned driving device and the target object, for example, indicate whether the unmanned driving device is in front of or behind the target object or on the left or right of the target object. Furthermore, a relative speed relation between the unmanned driving device and the target object at each moment may be further determined through the first trajectory and the second trajectory. The relative speed relation mentioned herein may represent a relative speed between the unmanned driving device and the target object numerically or represent a speed direction of the unmanned driving device relative to the target object.

The foregoing unmanned driving device may be an unmanned vehicle, an unmanned aerial vehicle, an automatic delivery device, or another device that can implement automatic driving. Based on the above, through the method for controlling an unmanned driving device provided by the present disclosure, the interactive behavior between the unmanned driving device and the target object can be determined during the traveling of the unmanned driving device. The unmanned driving device may be applied to the field of delivery using unmanned driving devices, for example, service scenarios such as delivery of express, logistics, takeaways using unmanned driving devices.

At S103, the spatial relation between the unmanned driving device and the target object is coded according to a preset coding manner to obtain spatial coding information, where each code in the spatial coding information is configured to represent a spatial relation between the unmanned driving device and the target object at a moment corresponding to the code.

In accordance with the present disclosure, after determining the spatial relation between the unmanned driving device and the target object, the unmanned driving device may code the spatial relation according to the preset coding manner to obtain the spatial coding information. Each code in the spatial coding information is configured to represent a spatial relation between the unmanned driving device and the target object at a moment corresponding to the code. The spatial coding information may include coding information obtained by coding a relative position relation or coding information obtained by coding a relative speed relation.

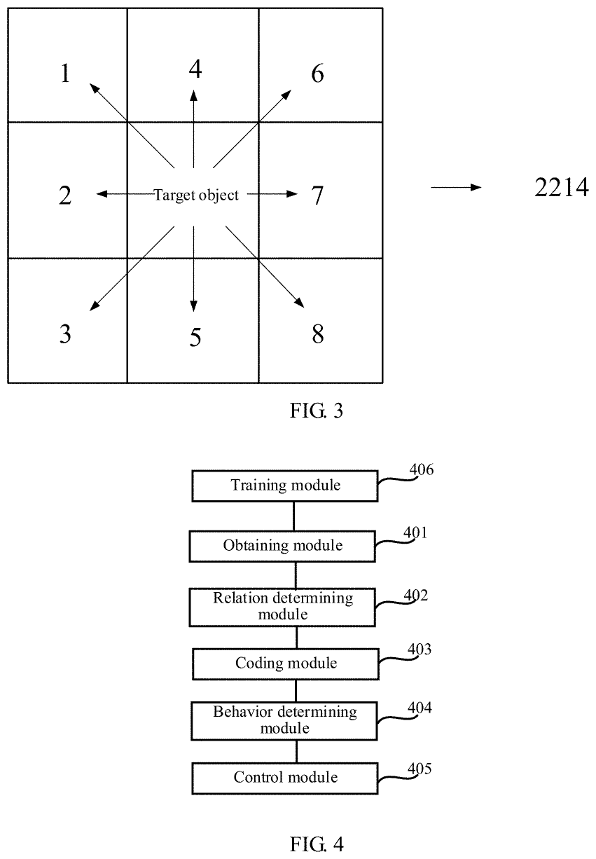

In the present disclosure, there may be various preset coding manners. For example, different spatial relations may be set to different codes to obtain the spatial coding information as shown in FIG. 3.

FIG. 3 is a schematic diagram of coding the relative position relation included in the spatial relation. The left part of FIG. 3 is a schematic diagram of coding a relative position relation between the unmanned driving device and the target object at a specific moment. It can be learned that the center of the nine-square grid is the position of the target object, and different codes correspond to different relative position relations. The eight codes from 1 to 8 may respectively indicate eight different relative position relations, and each of the codes can indicate an approximate orientation of the unmanned driving device relative to the target object.

In FIG. 3, the codes are determined with the target object in the center of the nine-square grid. The code 1 may indicate that the unmanned driving device is on the front left of the target object, the code 2 may indicate that the unmanned driving device is on the left of the target object, the code 3 may indicate that the unmanned driving device is on the left rear of the target object, the code 4 may indicate that the unmanned driving device is in front of the target object, the code 5 may indicate that the unmanned driving device is behind the target object, the code 6 may indicate that the unmanned driving device is on the front right of the target object, the code 7 may indicate that the unmanned driving device is on the right of the target object, and the code 8 may indicate that the unmanned driving device is on the right rear of the target object. In another embodiment, the unmanned driving device may be alternatively set in the center of the nine-square grid to determine the codes.

For each code, the code does not indicate a fixed direction, but may indicate that the unmanned driving device is located in a specific direction range. For example, the code 5 does not indicate that the unmanned driving device is on the right behind of the target object, and the relative position relation between the unmanned driving device and the target object may be represented by the code 5 as long as the unmanned driving device is within a specific angle range (for example, within a range of −30° to 30°) behind the target object. A specific angle range corresponding to each code may be set in advance.

For a moment, a relative position relation between the unmanned driving device and the target object at the moment may be represented by a code. Therefore, the relative position relation between the unmanned driving device and the target object at a plurality of moments may be determined by using the transformed first trajectory and the transformed second trajectory and coded, for example, “2214” at the right part of FIG. 3 is the spatial coding information of the relative position relation at four moments. That is, the unmanned driving device is on the left of the target object at the first moment and is still on the left of the target object at the second moment, and the unmanned driving device moves to the left front of the target object at the third moment and moves to the right ahead of the target object at the fourth moment.

The method for coding the relative position relation is described in the above. The relative speed relation may also be coded in a similar manner. For example, the number 2 indicates that the unmanned driving device travels at a lower speed and in the same speed direction as the target object, the number 1 indicates that the unmanned driving device travels at the same speed and in a speed direction to the left relative to the target object, the number 4 indicates that the unmanned driving device travels at roughly the same speed and in the same direction as the target object, and the number 6 indicates that the unmanned driving device travels at a higher speed relative to the target object. A specific number corresponding to a specific relative speed relation may be preset, and the relative position relation may also be preset.

The spatial relation may be the relative position relation or the relative speed relation. Therefore, the unmanned driving device may code the relative position relation and then obtain position codes, and code the relative speed relation and then obtain speed codes. The position codes and the speed codes are all used as the spatial coding information. In some embodiments, the spatial coding information may include merely the position codes or merely the speed codes.

At S104, an interactive behavior between the unmanned driving device and the target object is determined according to the spatial coding information.

After determining the spatial coding information, the unmanned driving device may determine the interactive behavior between the unmanned driving device and the target object according to the spatial coding information. The interactive behavior mentioned herein may include the unmanned driving device is overtaking the target object, the unmanned driving device is following the target object, the target object and the unmanned driving device are passing by each other, or the like.

There may be various methods for determining the interactive behavior between the unmanned driving device and the target object by the unmanned driving device according to the spatial coding information. For example, for each interactive behavior, a coding sequence corresponding to the interactive behavior may be preset. If the spatial coding information matches the coding sequence of one of the interactive behaviors, it is determined that the unmanned driving device is in the interactive behavior. In an embodiment, when the unmanned driving device determines a coding sequence matching the spatial coding information, the unmanned driving device may determine a coding sequence that is consistent with the codes in the spatial coding information in a specific ratio. For example, a coding sequence corresponding to an interactive behavior that the unmanned driving device overtakes the target object is preset to 214, and the spatial coding information is 24, it may be determined that the unmanned driving device is currently overtaking the target object. In another embodiment, if the spatial coding information includes each encode in a specific coding sequence, the coding sequence may also be determined as a coding sequence matching the spatial coding information. For example, a coding sequence corresponding to an interactive behavior that the unmanned driving device follows the target object is preset to 5, and the spatial coding information is 555, it may be determined that the unmanned driving device is currently following the target object.

In some embodiments, the interactive behavior between the unmanned driving device and the target object may be determined in another manner. For example, the unmanned driving device may input the determined spatial coding information into a pre-trained identification model to determine the interactive behavior between the unmanned driving device and the target object. The identification model may be an identification model obtained through supervised training in advance. That is, a server pre-obtains several training samples labeled with interactive behaviors, trains the identification model, and deploys the identification model on the unmanned driving device after the training is completed.

When the server trains the identification model, a historical travel trajectory of the unmanned driving device may be determined as a first historical trajectory, and a travel trajectory of a historical target object around the unmanned driving device during traveling of the unmanned driving device on the historical travel trajectory may be determined as a second historical trajectory. Next, the server may determine a historical spatial relation between the unmanned driving device and the historical target object and determine a historical interactive behavior between the unmanned driving device and the historical target object according to the first historical trajectory and the second historical trajectory. The historical interactive behavior may be an interactive behavior between the unmanned driving device and the historical target object when the unmanned driving device travels on the first historical trajectory.

The server may code the historical spatial relation between the unmanned driving device and the historical target object according to the preset coding manner to obtain historical coding information, input the historical coding information into a to-be-trained identification model to obtain a predicted interactive behavior between the unmanned driving device and the historical target object as a predicted interactive behavior, and train the identification model by using minimization of a difference between the historical interactive behavior and the predicted interactive behavior as an optimization objective.

The identification model may include a convolutional neural network and a fully-connected layer, and feature extraction is performed on the spatial coding information by using the convolutional neural network. After feature information is obtained, the feature information may be inputted into the fully-connected layer to predict the interactive behavior between the unmanned driving device and the target object. The convolutional neural network may include a plurality of convolution kernels. The spatial coding information may be respectively convolved through the convolution kernels to obtain different convolution results, and each of the convolution results is then pooled to obtain a pooling result. Subsequently, the pooling results are fused, for example, concatenated or added, to obtain the final feature information.

It should be noted that, if the spatial coding information includes a duplicate code, the duplicate code included in the spatial coding information may be deduplicated to obtain the deduplicated spatial coding information, and the interactive behavior between the unmanned driving device and the target object is determined according to the deduplicated spatial coding information. For example, in the spatial coding information “2214” mentioned in the above, there are duplicate codes 2, and the spatial coding information may be deduplicate to obtain “214”. In this way, codes that can indicate all behaviors of the unmanned driving device changing relative to the target object are retained, and the spatial coding information is simplified, thereby improving the efficiency of identifying the interactive behavior to a certain extent. Certainly, during the deduplication of the spatial coding information, the speed codes and the position codes are to be deduplicated separately, and the two types of information in different dimensions should not considered as the same type of information for deduplication.

It should be further noted that, during the traveling of the unmanned driving device, some codes may be missing from the spatial coding information for signal reason, external reason, or the like. In this case, the unmanned driving device may supplement the missing codes to make the spatial coding information complete. In some embodiments, in a case that the unmanned driving device determines that a code is missing from the spatial coding information, the unmanned driving device may determine a spatial relation change status between the unmanned driving device and the target object according to the codes included in the spatial coding information , perform code supplementary on the spatial coding information according to the spatial relation change status to obtain the supplemented spatial coding information, and determine the interactive behavior between the unmanned driving device and the target object according to the supplemented spatial coding information.

In the above, after the unmanned driving device determines that a code is missing from the spatial coding information, the unmanned driving device determines the spatial relation change status according to the codes included in the spatial coding information, which means that the spatial relation change status is determined according to remaining codes in the spatial coding information. For example, for the relative position relation, in a case that the unmanned driving device is on the left of the target object initially, a position at a middle moment is missing, and the unmanned driving device directly reaches the front of the target object at the next moment, if the spatial coding information includes “2_4”, and the underline in the middle represents a missing code, it can be determined that the missing code is 1, because the unmanned driving device may first move to the left front of the target object and then move to the front of the target object. It can be learned that the spatial relation change status is the law of spatial relation changes that are of the unmanned driving device relative to the target object and that are indicated by the codes not missing from the spatial coding information. Therefore, the code that is to be supplemented can be determined through the spatial relation change status.

At S105, the unmanned driving device is controlled according to the interactive behavior.

After determining the interactive behavior between the unmanned driving device and the target object, the unmanned driving device may determine a subsequent policy and control itself according to the interactive behavior.

For example, if the unmanned driving device determines that it is currently passing by the target object, that is, the target object is traveling towards the unmanned driving device, the unmanned driving device is to determine an avoidance policy for the target object and control itself to avoid the target object. Similarly, if the unmanned driving device determines another interactive behavior, the unmanned driving device also is to determine a corresponding policy to control itself, so as to ensure the travel safety of the unmanned driving device.

The above descriptions are made by using an example in which the unmanned driving device is an execution body and determines an interactive behavior of the unmanned driving device by using this method during traveling of the unmanned driving device. During actual application, this solution may be further configured to label training samples. That is, training samples that are not labeled may be automatically labeled by using this solution, to obtain more training samples and continue to train the identification model.

From the foregoing method, it can be learned that the unmanned driving device can code the spatial relation between the unmanned driving device and the target object around to obtain the spatial coding information, and then determine, according to the spatial coding information, the interactive behavior that the unmanned driving device is in. Furthermore, the unmanned driving device can input the spatial coding information into the identification model obtained through supervised training in advance, to obtain the predicted interactive behavior, which does not require redundant features identified from images, point clouds, or the like to determine the interactive behavior, thereby improving the efficiency of identifying the interactive behavior.

The above describes the method for controlling an unmanned driving device provided by one or more embodiments of the present disclosure. Based on the same idea, the present disclosure further provides a corresponding apparatus for controlling an unmanned driving device as shown in FIG. 4.

FIG. 4 is a schematic diagram of an apparatus for controlling an unmanned driving device according to the present disclosure. The apparatus includes: an obtaining module 401, configured to obtain a travel trajectory of an unmanned driving device as a first trajectory, and obtain a travel trajectory of a target object around the unmanned driving device as a second trajectory; a relation determining module 402, configured to determine a spatial relation between the unmanned driving device and the target object according to the first trajectory and the second trajectory; a coding module 403, configured to code the spatial relation between the unmanned driving device and the target object according to a preset coding manner to obtain spatial coding information, where each code in the spatial coding information is configured to represent a spatial relation between the unmanned driving device and the target object at a moment corresponding to the code; a behavior determining module 404, configured to determine an interactive behavior between the unmanned driving device and the target object according to the spatial coding information; and a control module 405, configured to control the unmanned driving device according to the interactive behavior.

In some embodiments, the first trajectory and the second trajectory are travel trajectories in a world coordinate system; and the relation determining module 402 is configured to: transform the first trajectory into a travel trajectory in a road coordinate system to obtain the transformed first trajectory, and transform the second trajectory into a travel trajectory in the road coordinate system to obtain the transformed second trajectory; and determine the spatial relation between the unmanned driving device and the target object according to the transformed first trajectory and the transformed second trajectory.

In some embodiments, the behavior determining module 404 is configured to: input the spatial coding information into a pre-trained identification model to determine the interactive behavior between the unmanned driving device and the target object.

In some embodiments, the apparatus further includes: a training module 406, configured to determine a historical travel trajectory of the unmanned driving device as a first historical trajectory, and determine a travel trajectory of a historical target object around the unmanned driving device during traveling of the unmanned driving device on the historical travel trajectory as a second historical trajectory; determine a historical spatial relation between the unmanned driving device and the historical target object and determine a historical interactive behavior between the unmanned driving device and the historical target object according to the first historical trajectory and the second historical trajectory; code the historical spatial relation between the unmanned driving device and the historical target object according to the preset coding manner to obtain historical coding information, and input the historical coding information into a to-be-trained identification model to obtain a predicted interactive behavior between the unmanned driving device and the historical target object as a predicted interactive behavior; and train the identification model by using minimization of a difference between the historical interactive behavior and the predicted interactive behavior as an optimization objective.

In some embodiments, the spatial relation includes: at least one of a relative speed relation between the unmanned driving device and the target object or a relative position relation between the unmanned driving device and the target object.

In some embodiments, the behavior determining module 404 is configured to: deduplicate a duplicate code included in the spatial coding information to obtain the deduplicated spatial coding information; and determine the interactive behavior between the unmanned driving device and the target object according to the deduplicated spatial coding information.

In some embodiments, the behavior determining module 404 is configured to: in response to determining that a code is missing from the spatial coding information, determine a spatial relation change status between the unmanned driving device and the target object according to the codes included in the spatial coding information; perform code supplementary on the spatial coding information according to the spatial relation change status to obtain the supplemented spatial coding information; and determine the interactive behavior between the unmanned driving device and the target object according to the supplemented spatial coding information.

The present disclosure further provides a computer-readable storage medium, storing a computer program, the computer program being configured to implement the foregoing method for controlling an unmanned driving device shown in FIG. 1.

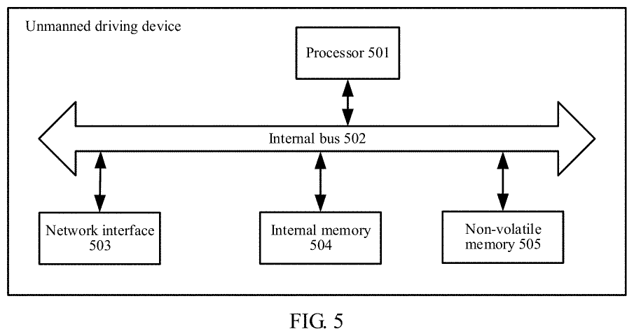

The present disclosure further provides a schematic structural diagram of an unmanned driving device that is shown in FIG. 5 and corresponds to FIG. 1. As shown in FIG. 5, at the hardware level, the unmanned driving device includes a processor 501, an internal bus 502, a network interface 503, an internal memory 504, and a non-volatile memory 505, and may further include hardware required for other services. The processor reads a corresponding computer program from the non-volatile storage into the memory and then runs the computer program to implement the method for controlling an unmanned driving device shown in FIG. 1. Definitely, in addition to a software implementation, the present disclosure does not exclude other implementations, for example, a logic device or a combination of software and hardware. In other words, an entity executing the following processing procedure is not limited to the logic units, and may also be hardware or logic devices.

In the 1990s, improvements of a technology can be clearly distinguished between hardware improvements (for example, improvements to a circuit structure such as a diode, a transistor, or a switch) and software improvements (improvements to a method procedure). However, with the development of technology, improvements of many method procedures can be considered as direct improvements of hardware circuit structures. Designers almost all program an improved method procedure to a hardware circuit, to obtain a corresponding hardware circuit structure. Therefore, it does not mean that the improvement of a method procedure cannot be implemented by using a hardware entity module. For example, a programmable logic device (PLD) such as a field programmable gate array (FPGA) is a type of integrated circuit whose logic function is determined by a user by programming the device. The designers perform voluntary programming to “integrate” a digital system into a single PLD without requiring a chip manufacturer to design and prepare a dedicated integrated circuit chip. Moreover, nowadays, instead of manually making integrated circuit chips, this programming is mostly implemented by using “logic compiler” software, which is similar to the software compiler used in program development and writing. The original code is written in a specific programming language before compiling, and this language is referred to as a hardware description language (HDL). There are various kinds of HDLs, for example, advanced Boolean expression language (ABEL), altera hardware description language (AHDL), Confluence, Cornell university programming language (CUPL), HDCal, Java hardware description language (JHDL), Lava, Lola, MyHDL, PALASM, Ruby hardware description language (RHDL), and the like. Currently, the most commonly used HDLs are very-high-speed integrated circuit hardware description language (VHDL) and Verilog. A person skilled in the art should also understand that provided that a method procedure is logically programmed and then programmed to an integrated circuit by using the foregoing hardware description languages, a hardware circuit that implements the logical method procedure can be easily obtained.

The controller can be implemented in any suitable manner, for example, the controller can take the form of, for example, a microprocessor or processor and a computer-readable medium storing computer-readable program code (for example, software or firmware) executable by the processor, a logic gate, a switch, an application-specific integrated circuit (ASIC), a programmable logic controller and an embedded microcontroller. Examples of the controller include, but are not limited to, the following microcontrollers: ARC 625D, Atmel AT91SAM, Microchip PIC18F26K20, and Silicone Labs C8051F320. The memory controller can also be implemented as part of the memory control logic. A person skilled in the art will also appreciate that, in addition to implementing the controller in the form of pure computer-readable program code, it is also possible to implement, by logically programming the method steps, the controller in the form of a logic gate, switch, ASIC, programmable logic controller, and embedded microcontroller and other forms to achieve the same function. Such a controller can thus be considered as a hardware component and apparatuses included therein for implementing various functions can also be considered as structures inside the hardware component. Alternatively, apparatuses configured to implement various functions can be considered as both software modules implementing the method and structures inside the hardware component.

The system, the apparatus, the module or the unit described in the foregoing embodiments may be implemented by a computer chip or an entity specifically, or implemented by a product having a certain function. A typical implementation device is a computer. Specifically, the computer may be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, when the apparatus is described, the apparatus is divided into units according to functions, which are separately described. Certainly, during implementation of the present disclosure, the functions of the units may be implemented in the same piece of or a plurality of pieces of software and/or hardware.

A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a disk memory, a CD-ROM, an optical memory, and the like) that include computer-usable program code.

The present disclosure is described with reference to the flowcharts and/or block diagrams of the method, the device (system), and the computer program product according to the embodiments of the present disclosure. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the general-purpose computer or the processor of another programmable data processing device.

These computer program instructions may also be stored in a computer readable memory that can instruct a computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded into a computer or another programmable data processing device, so that a series of operation steps are performed on the computer or another programmable data processing device to generate processing implemented by a computer, and instructions executed on the computer or another programmable data processing device provide steps for implementing functions specified in one or more procedures in the flowcharts and/or one or more blocks in the block diagrams.

In a typical configuration, the computer device includes one or more processors (CPUs), an input/output interface, a network interface, and an internal memory.

The internal memory may include, among computer-readable media, a non-persistent memory such as a random access memory (RAM) and/or a non-volatile memory such as a read-only memory (ROM) or a flash memory (flash RAM). The memory is an example of the computer-readable medium.

The computer-readable medium includes a non-volatile medium and a volatile medium, a removable medium and a non-removable medium, which may implement storage of information by using any method or technology. The information may be a computer-readable instruction, a data structure, a program module, or other data. Examples of the storage medium of the computer include, but are not limited to, a phase-change memory (PRAM), a static random access memory (SRAM), a dynamic random access memory (DRAM), or other types of random access memory (RAM), a read-only memory (ROM), an erasable programmable read-only memory (EEPROM), a flash memory or another storage technology, a compact disc read-only memory (CD-ROM), a digital versatile disc (DVD) or another optical storage, a cartridge tape, a magnetic tape, a magnetic disk storage or another magnetic storage device, or any other non-transmission medium, which may be configured to store information accessible by a computing device. According to limitations of the present disclosure, the computer-readable medium does not include transitory computer-readable media, such as a modulated data signal and a modulated carrier.

It should be further noted that the term “include,” “comprise,” or any other variants are intended to cover a non-exclusive inclusion, so that a process, a method, a commodity, or a device that includes a series of elements not only includes such elements, but also includes other elements not expressly listed, or further includes elements inherent to such a process, method, commodity, or device. Unless otherwise specified, an element limited by “include a/an . . . ” does not exclude other same elements existing in the process, the method, the article, or the device that includes the element.

The present disclosure can be described in the general context of computer-executable instructions executed by a computer, for example, program modules. Generally, the program module includes a routine, a program, an object, a component, a data structure, and the like for executing a particular task or implementing a particular abstract data type. The present disclosure may also be implemented in a distributed computing environment in which tasks are performed by remote processing devices connected by using a communication network. In a distributed computing environment, the program module may be located in both local and remote computer storage media including storage devices.

The embodiments of the present disclosure are all described in a progressive manner, for same or similar parts in the embodiments, refer to these embodiments, and descriptions of each embodiment focus on a difference from other embodiments. Especially, a system embodiment is basically similar to a method embodiment, and therefore is described briefly; for related parts, reference may be made to partial descriptions in the method embodiment.

The descriptions are merely embodiments of the present disclosure, and are not intended to limit the present disclosure. For a person skilled in the art, various modifications and changes may be made to the present disclosure. Any modifications, equivalent replacements, and improvements made within the spirit and principle of the present disclosure shall fall within the scope of the claims of the present disclosure.

1. A method for controlling an unmanned driving device, comprising:
obtaining a travel trajectory of an unmanned driving device as a first trajectory, and obtaining a travel trajectory of a target object around the unmanned driving device as a second trajectory;
determining a spatial relation between the unmanned driving device and the target object according to the first trajectory and the second trajectory;
coding the spatial relation between the unmanned driving device and the target object according to a preset coding manner to obtain spatial coding information, wherein each code in the spatial coding information is configured to represent a spatial relation between the unmanned driving device and the target object at a moment corresponding to the code;
determining an interactive behavior between the unmanned driving device and the target object according to the spatial coding information; and
controlling the unmanned driving device according to the interactive behavior.

2. The method according to claim 1, wherein the first trajectory and the second trajectory are travel trajectories in a world coordinate system; and, wherein
determining the spatial relation between the unmanned driving device and the target object according to the first trajectory and the second trajectory comprises:
transforming the first trajectory into a travel trajectory in a road coordinate system to obtain a transformed first trajectory, and transforming the second trajectory into a travel trajectory in the road coordinate system to obtain a transformed second trajectory; and
determining the spatial relation between the unmanned driving device and the target object according to the transformed first trajectory and the transformed second trajectory.

3. The method according to claim 1, wherein determining the interactive behavior between the unmanned driving device and the target object according to the spatial coding information comprises:
inputting the spatial coding information into a pre-trained identification model to determine the interactive behavior between the unmanned driving device and the target object.

4. The method according to claim 3, wherein training the identification model comprises:
determining a historical travel trajectory of the unmanned driving device as a first historical trajectory, and determining a travel trajectory of a historical target object around the unmanned driving device during traveling of the unmanned driving device on the historical travel trajectory as a second historical trajectory;
determining, according to the first historical trajectory and the second historical trajectory, a historical spatial relation between the unmanned driving device and the historical target object, and a historical interactive behavior between the unmanned driving device and the historical target object;
coding the historical spatial relation between the unmanned driving device and the historical target object according to the preset coding manner to obtain historical coding information, and inputting the historical coding information into a to-be-trained identification model to obtain a predicted interactive behavior between the unmanned driving device and the historical target object as a predicted interactive behavior; and
training the identification model by using minimization of a difference between the historical interactive behavior and the predicted interactive behavior as an optimization objective.

5. The method according to claim 1, wherein the spatial relation comprises at least one of a relative speed relation between the unmanned driving device and the target object or a relative position relation between the unmanned driving device and the target object.

6. The method according to claim 1, wherein determining the interactive behavior between the unmanned driving device and the target object according to the spatial coding information comprises:
deduplicating a duplicate code comprised in the spatial coding information to obtain deduplicated spatial coding information; and
determining the interactive behavior between the unmanned driving device and the target object according to the deduplicated spatial coding information.

7. The method according to claim 1, wherein determining the interactive behavior between the unmanned driving device and the target object according to the spatial coding information comprises:
in response to determining that a code is missing from the spatial coding information, determining a spatial relation change status between the unmanned driving device and the target object according to codes comprised in the spatial coding information;
performing code supplementary on the spatial coding information according to the spatial relation change status to obtain supplemented spatial coding information; and
determining the interactive behavior between the unmanned driving device and the target object according to the supplemented spatial coding information.

8. An unmanned driving device, comprising:
a memory,
a processor; and
a computer program stored in the memory and executable by the processor such that when the program is executed by the processor, the processor is caused to perform:
obtaining a travel trajectory of an unmanned driving device as a first trajectory, and obtaining a travel trajectory of a target object around the unmanned driving device as a second trajectory;
determining a spatial relation between the unmanned driving device and the target object according to the first trajectory and the second trajectory;
coding the spatial relation between the unmanned driving device and the target object according to a preset coding manner to obtain spatial coding information, wherein each code in the spatial coding information is configured to represent a spatial relation between the unmanned driving device and the target object at a moment corresponding to the code;
determining an interactive behavior between the unmanned driving device and the target object according to the spatial coding information; and
controlling the unmanned driving device according to the interactive behavior.

9. The unmanned driving device according to claim 8, wherein the first trajectory and the second trajectory are travel trajectories in a world coordinate system; and, wherein
determining the spatial relation between the unmanned driving device and the target object according to the first trajectory and the second trajectory comprises:
transforming the first trajectory into a travel trajectory in a road coordinate system to obtain the transformed first trajectory, and transforming the second trajectory into a travel trajectory in the road coordinate system to obtain the transformed second trajectory; and
determining the spatial relation between the unmanned driving device and the target object according to the transformed first trajectory and the transformed second trajectory.

10. The unmanned driving device according to claim 8, wherein determining the interactive behavior between the unmanned driving device and the target object according to the spatial coding information comprises:
inputting the spatial coding information into a pre-trained identification model to determine the interactive behavior between the unmanned driving device and the target object.

11. The unmanned driving device according to claim 10, wherein training the identification model comprises:
determining a historical travel trajectory of the unmanned driving device as a first historical trajectory, and determining a travel trajectory of a historical target object around the unmanned driving device during traveling of the unmanned driving device on the historical travel trajectory as a second historical trajectory;
determining, according to the first historical trajectory and the second historical trajectory, a historical spatial relation between the unmanned driving device and the historical target object, and a historical interactive behavior between the unmanned driving device and the historical target object;
coding the historical spatial relation between the unmanned driving device and the historical target object according to the preset coding manner to obtain historical coding information, and inputting the historical coding information into a to-be-trained identification model to obtain a predicted interactive behavior between the unmanned driving device and the historical target object as a predicted interactive behavior; and
training the identification model by using minimization of a difference between the historical interactive behavior and the predicted interactive behavior as an optimization objective.

12. The unmanned driving device according to claim 8, wherein the spatial relation comprises at least one of a relative speed relation between the unmanned driving device and the target object or a relative position relation between the unmanned driving device and the target object.

13. The unmanned driving device according to claim 8, wherein determining the interactive behavior between the unmanned driving device and the target object according to the spatial coding information comprises:
deduplicating a duplicate code comprised in the spatial coding information to obtain deduplicated spatial coding information; and
determining the interactive behavior between the unmanned driving device and the target object according to the deduplicated spatial coding information.

14. The unmanned driving device according to claim 8, wherein determining the interactive behavior between the unmanned driving device and the target object according to the spatial coding information comprises:
in response to determining that a code is missing from the spatial coding information, determining a spatial relation change status between the unmanned driving device and the target object according to codes comprised in the spatial coding information;
performing code supplementary on the spatial coding information according to the spatial relation change status to obtain supplemented spatial coding information; and
determining the interactive behavior between the unmanned driving device and the target object according to the supplemented spatial coding information.

15. A non-transitory computer-readable storage medium storing a computer program such that when the computer program is executed by a processor, the processor is caused to perform:
obtaining a travel trajectory of an unmanned driving device as a first trajectory, and obtaining a travel trajectory of a target object around the unmanned driving device as a second trajectory;
determining a spatial relation between the unmanned driving device and the target object according to the first trajectory and the second trajectory;
coding the spatial relation between the unmanned driving device and the target object according to a preset coding manner to obtain spatial coding information, wherein each code in the spatial coding information is configured to represent a spatial relation between the unmanned driving device and the target object at a moment corresponding to the code;
determining an interactive behavior between the unmanned driving device and the target object according to the spatial coding information; and
controlling the unmanned driving device according to the interactive behavior.

16. The computer-readable storage medium according to claim 15, wherein determining the interactive behavior between the unmanned driving device and the target object according to the spatial coding information comprises:
inputting the spatial coding information into a pre-trained identification model to determine the interactive behavior between the unmanned driving device and the target object.

17. The computer-readable storage medium according to claim 16, wherein training the identification model comprises:
determining a historical travel trajectory of the unmanned driving device as a first historical trajectory, and determining a travel trajectory of a historical target object around the unmanned driving device during traveling of the unmanned driving device on the historical travel trajectory as a second historical trajectory;
determining, according to the first historical trajectory and the second historical trajectory, a historical spatial relation between the unmanned driving device and the historical target object, and determining a historical interactive behavior between the unmanned driving device and the historical target object;
coding the historical spatial relation between the unmanned driving device and the historical target object according to the preset coding manner to obtain historical coding information, and inputting the historical coding information into a to-be-trained identification model to obtain a predicted interactive behavior between the unmanned driving device and the historical target object as a predicted interactive behavior; and
training the identification model by using minimization of a difference between the historical interactive behavior and the predicted interactive behavior as an optimization objective.

18. The computer-readable storage medium according to claim 15, wherein the spatial relation comprises at least one of a relative speed relation between the unmanned driving device and the target object or a relative position relation between the unmanned driving device and the target object.

19. The computer-readable storage medium according to claim 15, wherein determining the interactive behavior between the unmanned driving device and the target object according to the spatial coding information comprises:
deduplicating a duplicate code comprised in the spatial coding information to obtain deduplicated spatial coding information; and
determining the interactive behavior between the unmanned driving device and the target object according to the deduplicated spatial coding information.

20. The computer-readable storage medium according to claim 15, wherein determining the interactive behavior between the unmanned driving device and the target object according to the spatial coding information comprises:
in response to determining that a code is missing from the spatial coding information, determining a spatial relation change status between the unmanned driving device and the target object according to codes comprised in the spatial coding information;
performing code supplementary on the spatial coding information according to the spatial relation change status to obtain the supplemented spatial coding information; and
determining the interactive behavior between the unmanned driving device and the target object according to the supplemented spatial coding information.
